(19) United States
(12) Patent Application Publication
(10) Pub. No.: US 2021/0237686 A1
(43) Pub. Date: Aug. 5, 2021

(54) SHARED SYSTEM AND CONTROL METHOD THEREFOR

(71) Applicant: KABUSHIKI KAISHA TOKAI RIKA DENKI SEISAKUSHO, Aichi (JP)

(72) Inventors: Yuichi INAMI, Aichi (JP); Masahiko OYA, Aichi (JP); Masahiro ARAKAWA, Aichi (JP); Tomohiro TSUCHIYA, Aichi (JP)

(73) Assignee: KABUSHIKI KAISHA TOKAI RIKA DENKI SEISAKUSHO, Aichi (JP)

(21) Appl. No.: 17/053,976

(22) PCT Filed: May 10, 2019
(86) PCT No.: PCT/JP2019/018675

§ 371 Date: Nov. 9, 2020

(30) Foreign Application Priority Data
May 15, 2018 (JP) 2018-093984

(51) Int. Cl. B60R 25/24; G07C 9/00

(52) U.S. Cl. CPC B60R 25/241; G07C 9/00309; G07C 2009/0096; G07C 2009/00539; G07C 2009/0042; G07C 9/00857

(57) ABSTRACT

A sharing system includes an authentication device arranged in an operation subject that can be entered and exited. The sharing system includes mobile terminals that obtain code information required to use the operation subject. The mobile terminals are allowed by the authentication device to operate the operation subject if authenticated through communication with the authentication device. The sharing system further includes a terminal checking unit that checks the number of the mobile terminals that are located near the authentication device and can communicate with the authentication device. The sharing system further includes a process execution unit that executes a process, in a case where the number of the mobile terminals checked by the terminal checking unit is more than one and any one of the mobile terminals is left forgotten in the operation subject, for allowing another one of the mobile terminals to operate the operation subject.

### TECHNICAL FIELD

The present invention relates to a sharing system that allows an operation subject to be used by mobile terminals of users and a method for controlling a sharing system.

### BACKGROUND ART

In the prior art, an example of a conventional sharing system in which the same operation subject is used by a number of persons is a car sharing system that allows the same vehicle to be used by a number of persons (refer to Patent Documents 1 and 2). In this type of car-sharing system, for example, the use of car sharing is registered in advance. After making a reservation for use of a vehicle with, for example, a mobile terminal (high-performance mobile phone, etc.), the use of the vehicle is permitted during a reserved period of time.

### PRIOR ART DOCUMENTS

### Patent Documents

Patent Document 1: Japanese Laid-Open Patent Publication No. 2016-115077

Patent Document 2: Japanese Laid-Open Patent Publication No. 2016-71834

### SUMMARY OF THE INVENTION

### Problems that the Invention is to Solve

This type of car sharing system is inconvenient when only the mobile terminal of the person who made the reservation is granted privilege to use the vehicle since other persons will not be able to use the vehicle. Thus, studies have been conducted to give vehicle operation privilege to multiple mobile terminals Further, it is also desirable in terms of usability that communication be automatically established to allow for the operation of the vehicle when a mobile terminal approaches the vehicle.

In this case, when a mobile terminal is left forgotten in the passenger compartment, a person outside the vehicle may lock the vehicle door with another mobile terminal and leave the vehicle. Under such a situation, the mobile terminal left forgotten in the passenger compartment will establish communication with the vehicle through automatic connection. Thus, a person outside the vehicle will not be able to unlock the vehicle door with another mobile terminal. This problem is not limited to a car sharing system in which a vehicle serves as an operation subject and also arises in a sharing system that allows an operation subject to be operated by multiple mobile terminals.

It is an objective of the present invention to provide a sharing system and a control method that allow a mobile terminal to operate an operation subject when another mobile device is left forgotten in the operation subject.

### Means for Solving the Problem

In one aspect, a sharing system includes an authentication device arranged in an operation subject that can be entered and exited and mobile terminals. The mobile terminals obtain code information required to use the operation subject. The mobile terminals are allowed by the authentication device to operate the operation subject if authenticated through communication with the authentication device. The sharing system includes a terminal checking unit that checks the number of the mobile terminals that are located near the authentication device and can communicate with the authentication device and a process execution unit that executes a process, in a case where the number of the mobile terminals checked by the terminal checking unit is more than one and any one of the mobile terminals is left forgotten in the operation subject, for allowing another one of the mobile terminals to operate the operation subject.

With this structure, even if a user forgets one of the mobile terminals in the operation subject, locks a door with another one of the mobile terminals, and leaves the operation subject, the operation subject can be operated with the other one of the mobile terminals.

In the sharing system, when the terminal checking unit receives a response from one of the mobile terminals to a call before communication connection, preferably, the terminal checking unit checks the number of the mobile terminals located near the authentication device during a fixed time from when the response is received by checking whether a response from another one of the mobile terminals is received. With this structure, a simple process of monitoring a response from the mobile terminals for a fixed time allows for recognition of the number of mobile terminals located nearby.

In the sharing system, when the number of the mobile terminals located near the authentication device is more than one, preferably, the process execution unit switches a connection mode of the mobile terminals for connection with the authentication device from automatic connection to manual connection. With this structure, even if one mobile terminal is forgotten in the operation subject, the mobile terminal requires to be manually operated for communication connection to the authentication device. Thus, a situation does not occur in which the mobile terminal that is left forgotten in the operation subject is connected to the authentication device in a manner allowing for communication.

In the sharing system, when communication between one of the mobile terminals and the authentication device is disrupted, preferably, the process execution unit checks whether there is a response from another one of the mobile terminals to a call transmitted from the authentication device before communication connection to determine whether the other one of the mobile terminals has been left forgotten in the operation subject, and when the process execution unit detects that the other one of the mobile terminals has been left forgotten, the process execution unit executes a process to cope with the other one of the mobile terminals that has been left forgotten. With this structure, even if the mobile terminal is forgotten in the operation subject, the process execution unit notifies the user accordingly. This prevents the mobile terminal from being left in the operation subject and improves the security of the mobile terminal against theft or the like.

In another aspect, a method for controlling a sharing system is provided. The sharing system includes an authentication device arranged in an operation subject that can be entered and exited and mobile terminals that obtain code information required to use the operation subject, where the mobile terminals are allowed by the authentication device to operate the operation subject if authenticated through communication with the authentication device. The method includes checking the number of the mobile terminals that are located near the authentication device and can communicate with the authentication device and executing a process, in a case where the number of the mobile terminals checked is more than one and any one of the mobile terminals is left forgotten in the operation subject, for allowing another one of the mobile terminals to operate the operation subject.

### Effects of the Invention

According to the present invention, a mobile terminal is allowed to operate an operation subject when another mobile device is left forgotten in the operation subject.

### BRIEF DESCRIPTION OF THE DRAWINGS

FIG. 1 is a diagram showing a sharing system according to one embodiment.

FIG. 2 is a diagram illustrating a procedure for authenticating code information.

FIG. 3 is a diagram illustrating a procedure for operating an onboard device with a mobile terminal.

FIG. 4 is a diagram illustrating a procedure for granting operation privilege.

FIG. 5 is a schematic diagram when entering a vehicle.

FIG. 6 is a schematic diagram when exiting the vehicle.

FIG. 7 is a flowchart showing a communication procedure when entering the vehicle.

FIG. 8 is a flowchart showing a communication procedure when exiting the vehicle.

### EMBODIMENTS OF THE INVENTION

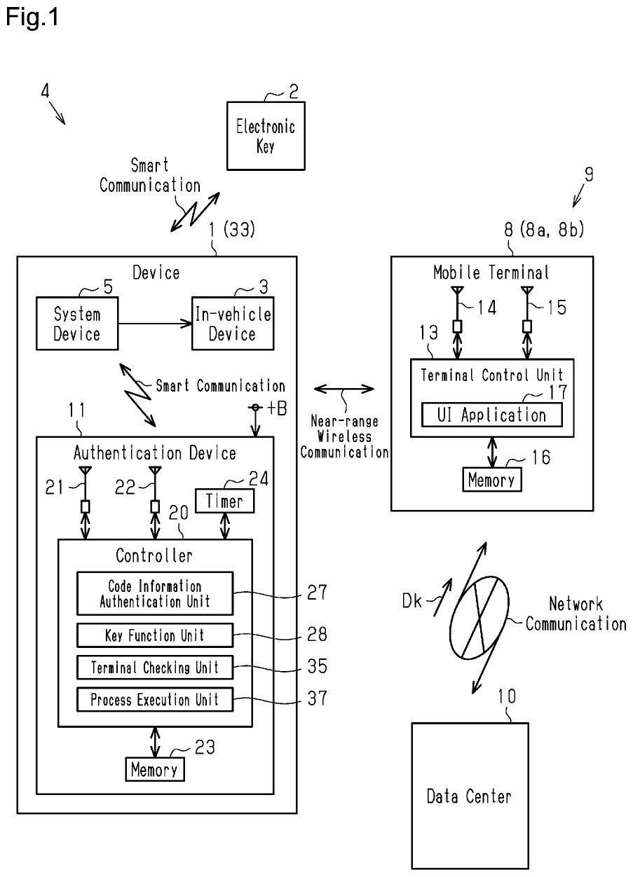

A sharing system and a control method according to one embodiment will now be described with reference to FIGS. 1 to 8.

As shown in FIG. 1, a vehicle 1 includes an electronic key system 4 in which ID verification is performed through wireless communication established with an electronic key 2 to execute or permit actuation of an in-vehicle device 3. The electronic key system 4 is a key-operation-free system in which ID verification (smart verification) is performed through near-range wireless communication when communication is established with the vehicle 1. The in-vehicle device 3 includes, for example, a door lock device and an engine.

The electronic key system 4 includes a system device 5 that actuates the electronic key system 4 in the vehicle 1. The electronic key 2 and the system device 5 store an electronic key ID and a unique electronic key encryption code that are used for smart verification. The electronic key 2 and the system device 5 perform the smart verification through bidirectional communication in which radio waves are transferred to each other. The smart verification includes, for example, electronic key ID verification that checks the authenticity of an electronic key ID or challenge-response authentication that uses the unique electronic key encryption code. Radio waves are transmitted from the system device 5 to the electronic key 2 in the low frequency (LF) band and from the electronic key 2 to the system device 5 in the ultra-high frequency (UHF) band.

The system device 5 performs smart communication with the electronic key 2 that is located outside the passenger compartment (exterior smart communication). If smart verification (exterior smart verification) is accomplished, the system device 5 permits or performs locking or unlocking of a vehicle door. Thus, touching of an exterior door handle unlocks the vehicle door, and operation of a lock button on the exterior door handle locks the vehicle door. The system device 5 also performs smart communication with the electronic key 2 that is located inside the passenger compartment (interior smart communication). If smart verification (interior smart verification) is accomplished, the system device 5 permits a shifting operation of a vehicle power supply. Then, an engine switch near the driver seat is pushed while a brake pedal is depressed to start the engine.

When the vehicle 1 is a shared vehicle shared by, for example, multiple persons, the vehicle 1 includes a sharing system 9, or a car sharing system that allows the vehicle 1 to be operated with a mobile terminal 8 carried by each user for a specified time that has been reserved. The sharing system 9 of the present example registers encrypted code information Dk from an external device (in present example, data center 10) to the mobile terminal 8. Further, the sharing system 9 authenticates the code information Dk with the mobile terminal 8 and an authentication device 11 arranged in the vehicle 1. The sharing system 9 uses the authentication result as one condition for allowing operation of the vehicle 1. The code information Dk is, for example, a type of key including a data element such as a usage time limit. Preferably, the code information Dk is a one-time key (one-time password) that can be used only once.

The mobile terminal 8 includes a terminal control unit 13, a network communication module 14, a near-range wireless communication module 15, and a memory 16. The terminal control unit 13 controls the actuation of the mobile terminal 8. The network communication module 14 performs network communication. The near-range wireless communication module 15 performs near-range wireless communication. Data is rewritable to the memory 16. When the mobile terminal 8 obtains the code information Dk through network communication from the data center 10, the mobile terminal 8 stores the code information Dk in the memory 16. Preferably, the near-range wireless communication is, for example, Bluetooth (registered trademark) communication.

The mobile terminal 8 includes a user interface application 17 that manages the actuation of the sharing system 9. The user interface application 17 is downloaded from, for example, the data center 10 and installed in the terminal control unit 13. The terminal control unit 13 executes the user interface application 17 to perform various types of processes such as a procedure for using the vehicle 1 (user authentication, reservation procedure), a locking or unlocking operation of a vehicle door, and a starting operation of the engine of the vehicle 1.

The authentication device 11 includes a controller 20 that controls actuation of the authentication device 11, a smart communication block 21 that performs smart communication, a near-range wireless communication module 22 that performs near-range wireless communication, a memory 23 that stores rewritable data, and a timer 24 that manages date and time. An authentication device ID registered in the authentication device 11 is linked to, for example, a vehicle body ID (vehicle body number) of the vehicle 1 so that the authentication device 11 has a one-to-one relationship with the vehicle 1. The timer 24 is, for example, a software timer.

The authentication device 11 includes a code information authentication unit 27 that authenticates the code information Dk registered to the mobile terminal 8 and a key function unit 28 that actuates the authentication device 11 in the same manner as the electronic key 2. The code information authentication unit 27 and the key function unit 28 are arranged in the controller 20. The code information authentication unit 27 obtains the code information Dk from the mobile terminal 8 through near-range wireless communication and authenticates the code information Dk. If the authentication of the code information Dk is accomplished, the code information authentication unit 27 shifts the key function unit 28 to an ON state (enabled). The key function unit 28, when shifted to the ON state, can perform smart communication (smart verification) with the electronic key system 4.

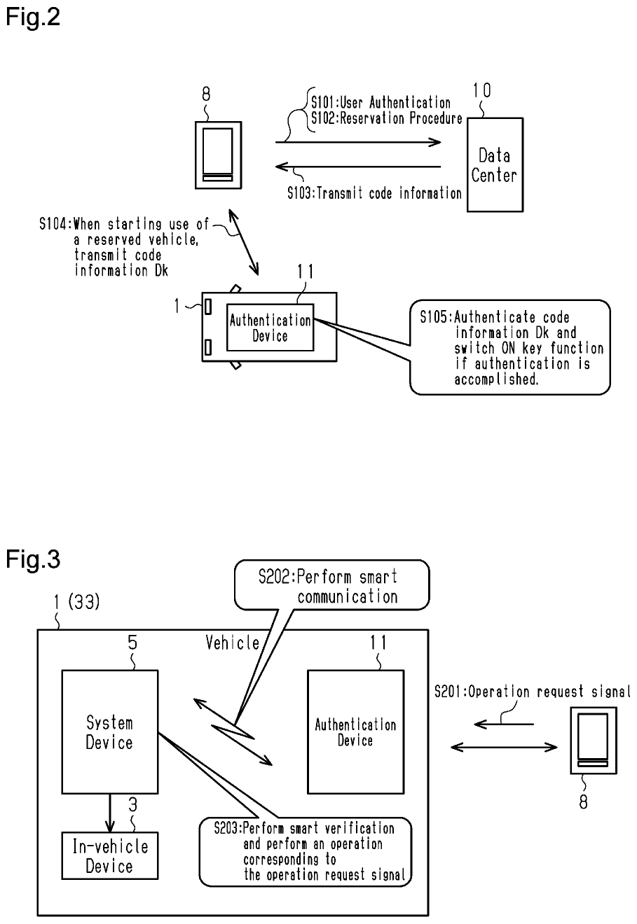

FIG. 2 shows the procedure for authenticating code information Dk. In step 101 of FIG. 2, the mobile terminal 8 performs user authentication with the data center 10 through network communication. The user authentication checks a user ID and a password that are assigned to the user when registering for use of the sharing system 9.

In step 102, the mobile terminal 8 performs a procedure for reserving the vehicle 1 with the data center 10 through network communication. In the reservation procedure, the used vehicle, the date and time of use, and the like are input and transmitted to the data center 10.

In step 103, if the user authentication is accomplished, the data center 10 generates and transmits code information Dk to the mobile terminal 8 through network communication. In this case, the data center 10 generates the code information Dk from information obtained in the reservation procedure. The code information Dk in the present example is ciphertext generated by encrypting plaintext including data elements such as “reserved date and time,” a “terminal ID,” a “user authentication code,” and a “group ID” with a cipher (encryption algorithm) using an encryption code (e.g. unique authentication device encryption code) of the authentication device 11 of a reserved vehicle. The terminal ID is a unique ID of the mobile terminal 8. The user authentication code is one type of code used in encrypted communication performed between the mobile terminal 8 and the authentication device 11 when operating the vehicle 1 with, for example, the mobile terminal 8. The group ID is a unique ID for identifying a group. The mobile terminal 8 receives code information Dk from the data center 10 and stores the code information Dk in the memory 16.

In step 104, when starting use of the reserved vehicle, the mobile terminal 8 transmits the code information Dk, which is registered in the mobile terminal 8, through near-range wireless communication. The code information Dk is transmitted to the authentication device 11 using, for example, Bluetooth Low Energy (BLE).

In step 105, the authentication device 11 receives the code information Dk from the mobile terminal 8 and authenticates the code information Dk. In the present example, the code information authentication unit 27 decrypts the code information Dk with the encryption code (e.g. unique authentication device encryption code) and checks whether the decryption is successful. When the decryption of the code information Dk is successful, the “reserved date and time, the “terminal ID,” the “user authentication code,”, and the “group ID” included in the code information Dk can be obtained. The vehicle 1 can be operated with the mobile terminal 8 for the specified time that has been reserved.

If the authentication of the code information Dk is successful, the authentication device 11 shifts to an “authentication completion state” with regard to the code information Dk and switches ON the key function unit 28 (smart function is activated). Thus, the key function unit 28 is allowed to perform smart communication (smart function) through the electronic key system 4. Further, when the authentication of the code information Dk is accomplished, the authentication device 11 stores the code information Dk and the user authentication code in the memory 23.

When the code information Dk is authenticated, the authentication device 11 performs near-range wireless communication to notify the mobile terminal 8 of the user authentication code obtained through the authentication. The mobile terminal 8 receives the user authentication code from the authentication device 11 and registers the user authentication code to the memory 16. In this manner, the user authentication code is registered to both of the mobile terminal 8 and the authentication device 11. When the mobile terminal 8 actuates the vehicle 1 through the authentication device 11, the user authentication code is used in encrypted communication between the mobile terminal 8 and the authentication device 11.

FIG. 3 illustrates a procedure for operating the vehicle 1 with the mobile terminal 8. In step 201 of FIG. 3, when an operation request button (display button on screen) of the mobile terminal 8 is operated in the authentication completion state, the mobile terminal 8 transmits an operation request signal, which corresponds to the button, to the authentication device 11 through near-range wireless communication. The operation request button may be an unlock request button operated to unlock, for example, a vehicle door, a lock request button operated to lock the vehicle door, or an engine start request button operated so that the vehicle 1 permits starting of the engine. The operation request signal includes a command corresponding to the operation request button that has been operated. The operation request signal is encrypted by, for example, the user authentication code when transmitted.

In step 202, when the operation request signal is received from the mobile terminal 8 when the key function unit 28 is in an ON state, the key function unit 28 performs the smart communication of the electronic key system 4 and notifies the system device 5 of the operation request signal received during the smart communication. In the present example, the key function unit 28 performs smart verification using the electronic key ID and the encryption code registered to the key function unit 28 and notifies the system device 5 of the operation request signal received from the mobile terminal 8 during the verification.

In step 203, when the system device 5 determines that smart verification performed with the authentication device 11 (key function unit 28) has been accomplished, the verification system device 5 performs an operation corresponding to the operation request signal notified by the authentication device 11. This locks or unlocks the vehicle door or permits an engine start operation.

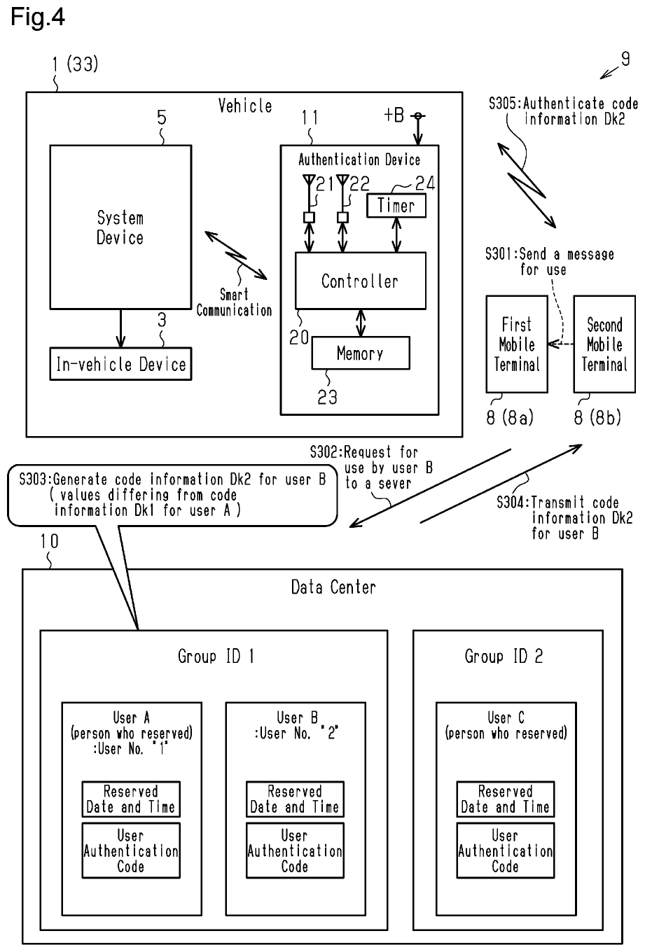

As shown in FIG. 4, the sharing system 9 includes a function that grants privilege to operate the vehicle 1 (operation authorization function) from the mobile terminal 8 (first mobile terminal 8a) that reserved the vehicle to another mobile terminal 8 (second mobile terminal 8b). The first mobile terminal 8a is a terminal used by the person who reserved the vehicle 1. The second mobile terminal 8b is a terminal used by a user that differs from the person who made the reservation (e.g., family member or the like). In the present example, the user of the first mobile terminal 8a, that is, the person reserving the vehicle 1 is referred to as “user A,” and the user of the second mobile terminal 8b, that is, a person that belongs to the same group as user A and is borrowing the vehicle 1 from user A is referred to as “user B.” A group to which user A belongs is “group ID1” and a user number for user A in the group is “1.”

In step 301, when user B uses the vehicle 1, user B sends a message for use of the vehicle 1 to user A. Preferably, the usage message is sent through, for example, a task in which user B operates his or her second mobile terminal 8b to send information indicating the desire to use the vehicle 1 to the first mobile terminal 8a carried by user A through network communication or near-range wireless communication.

In step 302, user A requests for the use of the vehicle by user B to the data center 10 by issuing operation privilege that permits user B to use the vehicle. In the present example, user A operates, for example, his or her first mobile terminal 8a to send the usage message received from user B to the data center 10. The data center 10 recognizes that user B and user A are in the same group and assigns “group ID1” to user B. In the request for use, the reserved date, time, and the like desired by user B are sent to the data center 10.

In step 303, the data center 10 sets user B to the same group (group ID1) as user A, assigns user number “2” in the group to user B, and then generates code information issued for user B (hereafter referred to as second code information Dk2). The second code information Dk2 generated by the data center 10 has values differing from the code information issued for user A (hereafter referred to as first code information Dk1). The second code information Dk2 is preferably ciphertext generated by encrypting plaintext including data elements such as a “group ID (in present example, group ID1),” a “reserved date and time,” a “terminal ID,” and a “user authentication code (differing from user authentication code included in first code information Dk1 issued for user A)” with a cipher (encryption algorithm) using a predetermined encryption code (e.g. unique authentication device encryption code or the like).

In step 304, the data center 10 sends the second code information Dk2 generated for user B to the second mobile terminal 8b of user B.

In step 305, the second mobile terminal 8b that has received the second code information Dk2 authenticates the second code information Dk2 when connected through near-range wireless communication to the authentication device 11 of the vehicle 1. The authentication of the second code information Dk2 is performed through the same process as steps 103 and 104 and will not be described. If the authentication of the second code information Dk2 is accomplished, the key function unit 28 is shifted to an ON state and the second mobile terminal 8b is granted privilege to operate the vehicle 1. In this manner, the grant of operation privilege is synonymous with an assignment (registration) of code information Dk. The second mobile terminal 8b is allowed to use the vehicle 1 in this manner.

User C in a group differing from that of users A and B may reserve the vehicle 1 from his or her mobile terminal 8. The data center 10 will recognize that user C is in a group differing from that of users A and B and thus assigns “group ID2” to user C as a group ID. The data center 10 generates different code information Dk for user C and issues the code information Dk to the mobile terminal 8 of user C. The mobile terminal 8 of user C authenticates the code information Dk, which is received from the data center 10, with the authentication device 11. If the authentication of the code information Dk is accomplished, the mobile terminal 8 is allowed to perform various types of operations on the vehicle 1. When user C is allowed to use the vehicle 1, users A and B with the group ID that differs from that of user C are not allowed to use the vehicle 1.

In FIG. 1, the sharing system 9 includes a function that prevents the mobile terminal 8 from being left forgotten in an operation subject 33 (vehicle 1 in present example) that can be entered and exited. In a conventional system, there may be multiple mobile terminals 8 that can operate the vehicle 1, and one of the mobile terminals 8 that is not connected to the authentication device 11 may be left forgotten in the passenger compartment when a user exits the vehicle 1. If the user outside the vehicle 1 locks the vehicle door with another mobile terminal 8 and communication is disrupted as the user leaves the vehicle 1, the mobile terminal 8 left forgotten in the passenger compartment will be automatically connected to the authentication device 11 in a manner allowing for communication. In this case, the mobile terminal 8 outside the vehicle 1 cannot communicate with the authentication device 11, and the vehicle door cannot be unlocked. The present example copes with this problem.

In the present example, the sharing system 9 includes a terminal checking unit 35 that checks the number of mobile terminals 8 that can communicate with the authentication device 11 of the operation subject 33 (in present example, vehicle 1). The terminal checking unit 35 is arranged in the controller 20 of the authentication device 11. The terminal checking unit 35 checks the number of mobile terminals 8 that can communicate (near-range wireless communication in present example) with the authentication device 11. Specifically, the terminal checking unit 35 in the present example checks the number of mobile terminals 8 that can perform near-range wireless communication with the authentication device 11 and are located near the authentication device 11 (vehicle 1).

Even if one of the mobile terminals 8 is left forgotten in the operation subject 33 (vehicle 1 in present example), the sharing system 9 includes a process execution unit 37 that executes a process allowing the operation subject 33 to be operable by another one of the mobile terminals 8. The process execution unit 37 is included in the controller 20. In the present example, the process execution unit 37 executes the above process if the number of mobile terminals 8 checked by the terminal checking unit 35 is more than one.

If there are multiple mobile terminals 8 near the authentication device 11 (in present example, communication area of authentication device 11 set inside and around vehicle 1 serving as operation subject 33), the process execution unit 37 switches the connection mode of the mobile terminal 8 to the authentication device 11 from automatic connection to manual connection. If communication (near-range wireless communication) between one mobile terminal 8 and the authentication device 11 is disrupted, the process execution unit 37 checks whether there is another mobile terminal 8 in the communication area of the authentication device 11 to determine whether a mobile terminal 8 is left forgotten in the vehicle 1. If the process execution unit 37 detects a forgotten mobile terminal 8, the process execution unit 37 executes a process that notifies the user accordingly.

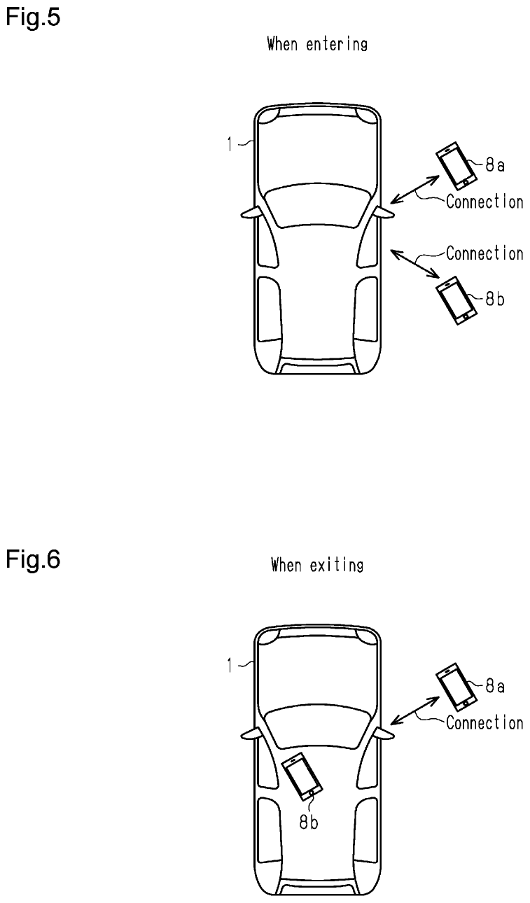

With reference to FIGS. 5 to 8, the operation and advantages of the sharing system 9 in the present embodiment will now be described.

As shown in FIG. 5, two mobile terminals 8 (first mobile terminal 8a and second mobile terminal 8b) approach and enter the vehicle 1 as users enter the vehicle 1. The first mobile terminal 8a and the second mobile terminal 8b are set as “partner keys.” Preferably, the partner keys are mobile terminals 8 to which the same group ID (in present example, group ID1) is assigned. The first mobile terminal 8a is used by a driver and the second mobile terminal 8b is used by a non-driver.

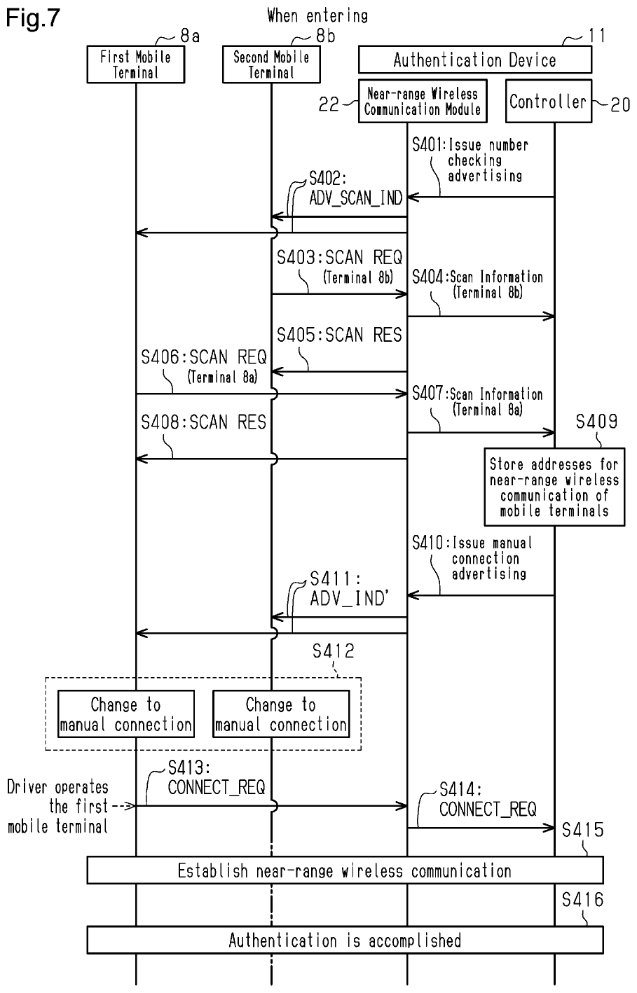

As shown in FIG. 7, in step 401, the terminal checking unit 35 of the controller 20, when establishing near-range wireless communication (Bluetooth), outputs a request for issuing an advertising packet that requests the checking of the number of mobile terminals 8 (hereafter referred to as “number checking advertising”) to the near-range wireless communication module 22.

When the request for issuing the number checking advertising is received from the controller 20, in step 402, the near-range wireless communication module 22 transmits an advertising scan indication (ADV_SCAN_IND) for searching for a connectable mobile terminal 8 through near-range wireless communication. In this case, the first mobile terminal 8a and the second mobile terminal 8b approach the vehicle 1. Thus, the scanning response advertising reaches both of the first mobile terminal 8a and the second mobile terminal 8b.

When the advertising scan indication is received, in step 403, as long as the second mobile terminal 8b is granted privilege to operate the vehicle 1 (code information Dk is assigned), the second mobile terminal 8b transmits a scan request that requests for information other than advertising to the authentication device 11 through near-range wireless communication. In this manner, the second mobile terminal 8b returns only the scan request in response to the advertising scan indication. At this time, the second mobile terminal 8b does not return a connect request, which will be described later. The scan request sent by the second mobile terminal 8b includes a near-range wireless communication address of the second mobile terminal 8b, that is, a Bluetooth address in the present example.

When the scan request from the second mobile terminal 8b is received, in step 404, the near-range wireless communication module 22 outputs scan information of the second mobile terminal 8b to the controller 20. The scan information is a data group in the scan request and includes, for example, the Bluetooth address of the second mobile terminal 8b.

In step 405, the near-range wireless communication module 22 transmits a scan response to the second mobile terminal 8b through near-range wireless communication. The scan response indicates that the scan request for the second mobile terminal 8b has been received.

When the advertising scan indication is received, in step 406, as long as the first mobile terminal 8a is granted privilege to operate the vehicle 1 (code information Dk is assigned), the first mobile terminal 8a transmits a scan request that requests for information other than advertising to the authentication device 11 through near-range wireless communication. The scan request sent by the first mobile terminal 8a includes a near-range wireless communication address of the first mobile terminal 8a, that is, a Bluetooth address in the present example.

When the scan request from the first mobile terminal 8a is received, in step 407, the near-range wireless communication module 22 outputs scan information (Bluetooth address) of the first mobile terminal 8a to the controller 20.

In step 408, the near-range wireless communication module 22 transmits a scan response to the first mobile terminal 8a through near-range wireless communication. The scan response indicates that the scan request for the first mobile terminal 8a has been received.

In step 409, the terminal checking unit 35 of the controller 20 stores the addresses for near-range wireless communication (Bluetooth addresses) obtained from the scan information of the mobile terminals 8 in the memory 23. In the present example, the terminal checking unit 35 stores the Bluetooth address of the first mobile terminal 8a and the Bluetooth address of the second mobile terminal 8b in the memory 23.

In step 410, if multiple addresses (Bluetooth addresses) for near-range wireless communication are stored, the process execution unit 37 outputs a request for issuing an advertising packet (request for issuing manual connection advertising) to the near-range wireless communication module 22. The advertising packet (hereafter referred to as “manual connection advertising”) is for switching the connection mode of the mobile terminals 8 (first mobile terminal 8a and second mobile terminal 8b) from automatic connection to manual connection.

When the request for issuing the manual connection advertising is received from the controller 20, in step 411, the near-range wireless communication module 22 transmits an advertising indication (ADV_IND′: manual connection requesting advertising) for requesting a change to manual connection through near-range wireless communication. In this case, the first mobile terminal 8a and the second mobile terminal 8b are approaching the vehicle 1. Thus, the advertising indication (ADV_IND′) reaches both of the first mobile terminal 8a and the second mobile terminal 8b.

In step 412, the first mobile terminal 8a and the second mobile terminal 8b receive the advertising indication (ADV_IND′) from the authentication device 11 and changes the connection mode for near-range wireless communication from automatic connection to manual connection. Thus, the first mobile terminal 8a and the second mobile terminal 8b are required to separately undergo a communication connection operation performed on the terminal to communicate with the authentication device 11. Preferably, the communication connection operation is tapping of a connection button displayed on the screen of the first mobile terminal 8a or the second mobile terminal 8b.

When the communication connection operation is performed on the first mobile terminal 8a in the manual connection state, in step 413, the first mobile terminal 8a transmits a connect request that requests for connection in near-range wireless communication to the authentication device 11 through near-range wireless communication.

When the connect request is received from the first mobile terminal, in step 414, the near-range wireless communication module 22 outputs the connect request to the controller 20.

When the connect request transmitted from the first mobile terminal 8a is obtained, in step 415, the controller 20 (authentication device 11) establishes near-range wireless communication with the first mobile terminal 8a. This allows the first mobile terminal 8a to perform near-range wireless communication with the authentication device 11.

After establishing near-range wireless communication with the first mobile terminal 8a, in step 416, the authentication device 11 performs authentication with the first mobile terminal 8a. The authentication may be authentication of code information Dk (first code information Dk), authentication of a user authentication code, or the like. If the authentication with the first mobile terminal 8a is accomplished, the authentication device 11 shifts to an authentication completion state and allows the first mobile terminal 8a to operate the vehicle 1. Thus, when the first mobile terminal 8a performs a locking or unlocking operation of the vehicle door, an operation request signal corresponding to the operation is transmitted from the first mobile terminal 8a to the authentication device 11, and locking or unlocking of the vehicle door is performed or permitted.

FIG. 6 shows a case in which a driver exits the vehicle, locks the vehicle door with his or her first mobile terminal 8a, and leaves the vehicle 1. The second mobile terminal 8b is left forgotten in the passenger compartment.

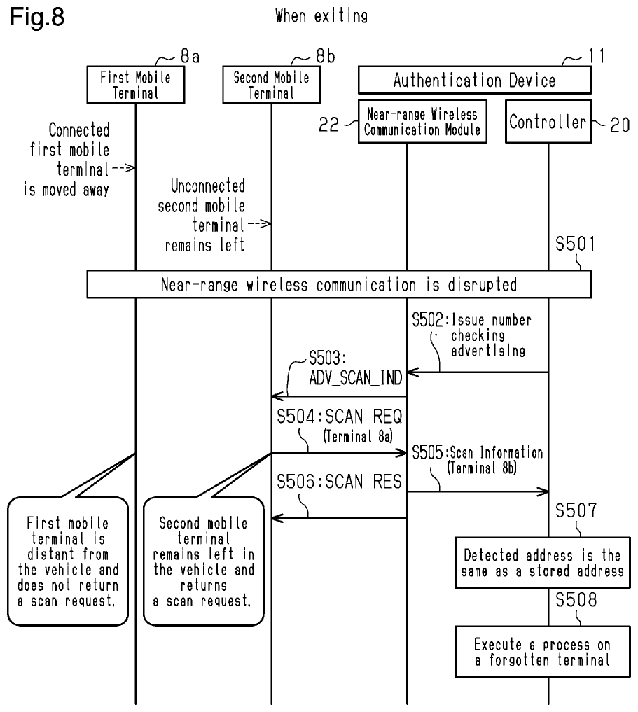

As shown in FIG. 8, in step 501, when the first mobile terminal 8a, which is connected to the authentication device 11, leaves the vehicle 1, the authentication device 11 will not be able to receive radio waves from the first mobile terminal 8a. Thus, near-range wireless communication with the first mobile terminal 8a since the authentication device 11 will be disrupted.

In step 502, when near-range wireless communication with one mobile terminal 8 (in present example, first mobile terminal 8a) is disrupted, the terminal checking unit 35 of the controller 20 outputs a request for issuing an advertising packet (number checking advertising) that requests the near-range wireless communication module 22 to check the number of mobile terminals 8.

When the request for issuing the number checking advertising is received from the controller 20, in step 503, the near-range wireless communication module 22 transmits an advertising scan indication (ADV_SCAN_IND) for searching for a connectable mobile terminal 8 through near-range wireless communication. In this case, the second mobile terminal 8b remains left in the vehicle 1. Thus, the advertising scan indication reaches only the second mobile terminal 8b.

When the second mobile terminal 8b receives the advertising scan indication, in step 504, as long as the second mobile terminal 8b is granted privilege to operate the vehicle 1 (code information Dk is assigned), the second mobile terminal 8b transmits a scan request that sends scan information of the second mobile terminal 8b to the authentication device 11 through near-range wireless communication. The first mobile terminal 8a is distant from the vehicle 1 and cannot return a scan request to the authentication device 11.

When the scan request is received from the second mobile terminal 8b, in step 505, the near-range wireless communication module 22 outputs scan information of the second mobile terminal 8b (Bluetooth address of second mobile terminal 8b) to the controller 20.

In step 506, the near-range wireless communication module 22 transmits a scan response to the second mobile terminal 8b through near-range wireless communication. The scan response indicates that the scan request for the second mobile terminal 8b has been received.

In step 507, the process execution unit 37 of the controller 20 checks whether the address (Bluetooth address) for near-range wireless communication that obtained from the scan information of the second mobile terminal 8b is the same as the address stored in the memory 23. If the detected address is the same as the stored address, the process execution unit 37 determines that the mobile terminal 8 (second mobile terminal 8b) has been left forgotten in the vehicle 1.

In step 508, the process execution unit 37 executes a process on the forgotten mobile terminal 8. Preferably, the process issues a notification with the vehicle 1 that the second mobile terminal 8b has been forgotten. Another process may use the first mobile terminal 8a that was not forgotten in the passenger compartment. In this case, for example, the authentication device 11 is connected to the second mobile terminal 8b that was forgotten in the passenger compartment. The authentication device 11 sends information indicating that the second mobile terminal 8b was forgotten via the second mobile terminal 8b in the passenger compartment to the data center 10, which is connected to the authentication device 11. The data center 10 sends a message to the first mobile terminal 8a indicating that the second mobile terminal 8b was forgotten. The first mobile terminal 8a notifies the user that the second mobile terminal 8b was forgotten.

In the present example, if the user outside the vehicle 1 locks the vehicle door with the first mobile terminal 8a and leaves the vehicle 1 with the second mobile terminal 8b left forgotten in the vehicle 1, the process execution unit 37 restricts automatic communication connection of the second mobile terminal 8b, which was forgotten in the vehicle 1, with the authentication device 11. In the present example, the process execution unit 37 switches the connection mode of the mobile terminals 8, which have been checked by the terminal checking unit 35, to the authentication device 11 from automatic connection to manual connection. Thus, even if the second mobile terminal 8b was left forgotten in the vehicle 1, the second mobile terminal 8b is not connected, in a manner allowing for connection, to the authentication device 11. This allows the first mobile terminal 8a to operate the vehicle 1 (vehicle door) from outside the vehicle 1. In this manner, the process execution unit 37 executes the process so that even if any one of the mobile terminals 8 is left forgotten in the vehicle 1, another one of the mobile terminals 8 can operate the vehicle 1.

If the terminal checking unit 35 receives a response (scan request) from one of the mobile terminals 8 in response to a call (advertising scan indication) before communication connection, the terminal checking unit 35 checks, during a fixed time from the response, whether a response is received from another mobile terminal 8 to determine the number of mobile terminals 8 that are located near the authentication device 11. Thus, the simple process of monitoring a response from the mobile terminals 8 for a fixed time allows for recognition of the number of mobile terminals 8 located nearby.

If the number of mobile terminals 8 located near the authentication device 11 is more than one, the process execution unit 37 switches the connection mode of the mobile terminals 8 from automatic connection to manual connection. Thus, if one mobile terminal 8 is forgotten in the passenger compartment, the mobile terminal 8 requires to be manually operated for communication connection to the authentication device 11. Thus, a situation does not occur in which the mobile terminal 8 that is left forgotten in the passenger compartment is connected to the authentication device 11 in a manner allowing for communication.

If the communication between one of the mobile terminals 8 and the authentication device 11 is disrupted, the process execution unit 37 determines whether another one of the mobile terminals 8 is left forgotten in the vehicle 1 by checking a response (scan request) of another one of the mobile terminals 8 in response to a call (advertising scan indication) transmitted by the authentication device 11 before communication connection. If the process execution unit 37 detects that a mobile terminal 8 has been forgotten, the process execution unit 37 executes a process for coping with the forgotten mobile terminal 8. Thus, if the mobile terminal 8 is forgotten in the passenger compartment, the process execution unit 37 notifies the user accordingly. This prevents the mobile terminal 8 from being left in the vehicle 1 and improves the security of the mobile terminal 8 against theft or the like.

The present embodiment may be modified as follows. The present embodiment and the following modifications can be combined as long as the combined modifications are not in contradiction.

The process executed by the process execution unit 37 does not have to switch the connection mode of the mobile terminals 8 from automatic connection to manual connection when determining that the number of mobile terminals 8 located near the authentication device 11 is more than one. For example, in the above embodiment, the connection mode of the second mobile terminal 8b forgotten in the passenger compartment may be kept in automatic connection. In this case, when communication with the first mobile terminal 8a is disrupted (step 501 in FIG. 8), the authentication device 11 may transmit a request for switching to manual connection to the second mobile terminal 8b. This modification has the same advantages as the above embodiment.

The number of mobile terminals 8 does not have to be checked when communication connection starts. For example, when communication with one of the mobile terminals 8 is established, a process of searching for another mobile terminal 8 can be started.

The number of mobile terminals 8 does not need to be checked through the transmission and reception of an advertising scan indication and a scan response. Instead, the number may be checked through other types of radio waves.

The process execution unit 37 may execute any process as long as the mobile terminal 8 forgotten in the passenger compartment is not in communication connection with the authentication device 11.

The advertising scan indication transmitted from the authentication device 11 may include, for example, information that actuates only the mobile terminal 8 of which code information Dk is registered in the authentication device 11. Only the mobile terminal 8 of which the code information Dk is registered in the authentication device 11 responds to the advertising from the authentication device 11. In this case, communication with only the relevant mobile terminal 8 starts in response to the advertising of the authentication device 11.

A scan request does not need to be transmitted by a mobile terminal 8 that is granted operation privilege and may be transmitted from a terminal that does not have operation privilege.

A call does not need to be an advertising scan indication. Instead, the call may be any signal to search for the mobile terminal 8.

A response does not need to be a scan request. Instead, the response may be any signal transmitted in reply to a call.

The second mobile terminal 8b may be a terminal set as a valet key.

The authentication device 11 may be retrofitted to the vehicle 1 or installed in the vehicle 1 in advance.

The authentication device 11 may be installed anywhere in the vehicle 1.

The operation of the mobile terminal 8 to actuate the vehicle 1 may be modified in various manners.

The reservation procedure for the vehicle 1 does not need to be performed by the mobile terminal 8. Instead, the reservation procedure may be performed by a different terminal.

Code information Dk does not need to be a one-time key. Instead, the code information Dk may be information including a data element for imposing limitations on time to use the code information Dk.

The content included in the code information Dk may be changed to forms other than that of the above embodiment.

The code information Dk does not need to be generated in the data center 10. Instead, the code information Dk may be generated in any external location.

The mobile terminal 8 does not need to be a high-performance mobile phone and may be replaced by any of various types of terminals.

The mobile terminal 8 and the authentication device 11 may obtain a user authentication code in any procedure or method.

The key function unit 28 may be switched to an ON state (enabled) under any condition.

Operation privilege may be granted to another user by, for example, having the terminal of the other user (second mobile terminal 8b) directly send an inquiry to the data center 10 and obtaining the operation privilege (code information Dk).

Near-range wireless communication does not need to be Bluetooth communication and may be changed to other communication protocols.

The communication between the mobile terminal 8 and the authentication device 11, the communication between the system device 5 and the authentication device 11, the communication between the electronic key 2 and the system device 5, and the communication between the mobile terminal 8 and the data center 10 may use various types of frequencies and communication protocols.

The electronic key system 4 does not need to be a key-operation-free system but may be replaced by other system structures.

The encryption code used in encrypted communication may be any one of code information Dk, unique authentication device encryption code, user authentication code, and unique electronic key encryption code. The switching of encryption codes used during a process improves the security of communication. Encryption codes that are used do not need to be the above codes and may be replaced by various types of codes.

The communication between the authentication device 11 and the controller 20 may be wired or wireless.

The system device 5 and the authentication device 11 do not need to be wireless-connected and may be wire-connected.

The authentication device 11 may output a command corresponding to a request received from the mobile terminal 8 to the system device 5 (wireless or wired communication) so that the vehicle 1 operates in response to the request obtained from the mobile terminal 8.

The operation subject 33 is not limited to the vehicle 1 and may be changed to other subjects, for example, a room of a lodging facility (in this case, mobile terminal 8 may be used to lock and unlock a room door or the like), a gate for a coin-operated parking lot, a shared delivery locker, or the like.

Facilities in which the operation subject 33 is disposed may be changed to various types of subjects such as private lodging facilities.

1. A sharing system, comprising:
an authentication device arranged in an operation subject that can be entered and exited;
mobile terminals that obtain code information required to use the operation subject, wherein the mobile terminals are allowed by the authentication device to operate the operation subject if authenticated through communication with the authentication device;
a terminal checking unit that checks the number of the mobile terminals that are located near the authentication device and can communicate with the authentication device; and
a process execution unit that executes a process, in a case where the number of the mobile terminals checked by the terminal checking unit is more than one and any one of the mobile terminals is left forgotten in the operation subject, for allowing another one of the mobile terminals to operate the operation subject.

2. The sharing system according to claim 1, wherein when the terminal checking unit receives a response from one of the mobile terminals to a call before communication connection, the terminal checking unit checks the number of the mobile terminals located near the authentication device during a fixed time from when the response is received by checking whether a response from another one of the mobile terminals is received.

3. The sharing system according to claim 1, wherein when the number of the mobile terminals located near the authentication device is more than one, the process execution unit switches a connection mode of the mobile terminals for connection with the authentication device from automatic connection to manual connection.

4. The sharing system according to claim 1, wherein when communication between one of the mobile terminals and the authentication device is disrupted, the process execution unit checks whether there is a response from another one of the mobile terminals to a call transmitted from the authentication device before communication connection to determine whether the other one of the mobile terminals has been left forgotten in the operation subject, and when the process execution unit detects that the other one of the mobile terminals has been left forgotten, the process execution unit executes a process to cope with the other one of the mobile terminals that has been left forgotten.

5. A method for controlling a sharing system, wherein the sharing system includes an authentication device arranged in an operation subject that can be entered and exited and mobile terminals that obtain code information required to use the operation subject, wherein the mobile terminals are allowed by the authentication device to operate the operation subject if authenticated through communication with the authentication device, the method comprising:
checking the number of the mobile terminals that are located near the authentication device and can communicate with the authentication device; and
executing a process, in a case where the number of the mobile terminals checked is more than one and any one of the mobile terminals is left forgotten in the operation subject, for allowing another one of the mobile terminals to operate the operation subject.
